(19) United States
(12) Patent Application Publication
(10) Pub. No.: US 2012/0175000 A1
(43) Pub. Date: Jul. 12, 2012

(54) COMPACT CARTRIDGE COUPLING

(76) Inventors: PAOLO RUSCONI, RIVOLTA D'ADDA (IT); ROCCO FERRARA, FARA GERA D'ADDA (IT)

(21) Appl. No.: 13/181,755

(22) Filed: Jul. 13, 2011

(30) Foreign Application Priority Data
Jul. 16, 2010 (EP) 10425242.4

(51) Int. Cl. F16L 37/30

(52) U.S. Cl. 137/614

(57) ABSTRACT

The present invention relates to a compact cartridge coupling of the type adapted to connect a pressurized fluid line between a vehicle or apparatus and a user, which coupling is of the type comprising a female semi-coupling adapted to receive a male semi-coupling.

The cartridge coupling according to the present invention is characterized in that it comprises decompression means adapted to moderate the pressure inside the female semi-coupling thus allowing a male semi-coupling under pressure to be coupled and allowing the male to be disconnected while leaving pressure in the user line. Moreover, the cartridge coupling is characterized by a 3:1 hydraulic unbalancing system between the pressure force acting on the female valve assembly and that acting on the male valve assembly.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a compact cartridge coupling.

Quick couplings according to ISO Standard 7241 are now consolidated on the international market, especially concerning the agricultural/forestry field. ISO standards regulate the sizes of the couplings in order to ensure the interchangeability of different manufacturers, the ability to be coupled and various minimum use requirements, such as pressure, capacity and so on.

Among the quick couplings according to the standard above, cartridge couplings are characterized by a compact design while maintaining the same functional principles of ISO Standard 7241.

In particular, cartridge couplings are inserted into a housing commonly made of cast iron in order to make the cartridge coupling employable with increased effectiveness where the operating conditions provide for high operating pressures, in particular also with sudden variations of the flow direction and particularly high pressure impulse frequencies.

Moreover, cartridge couplings are generally employed by positioning them inside the housings made of cast iron, for example, when the conditions of use provide for the presence of earth, mud and debris, such as precisely occurs in the case of uses in the agricultural and forestry field.

Therefore, one of the main drawbacks of the cartridge couplings known from the state of the art consists of the non-optimal reliability, with particular reference to the resistance and duration of the components and of the coupling as a whole.

Moreover, an improvable aspect of the cartridge couplings known from the state of the art consists in the overall volumes.

Therefore, it is the primary task of the present invention to suppress or reduce the above-mentioned drawbacks.

Therefore, it is the object of the present invention within the scope of this task to provide a quick cartridge coupling which is characterized by an overall reduced volume, so as to be arranged in narrow spaces.

It is also a further object of the present invention to provide a quick cartridge coupling equipped with a decompression system which permits to moderate the pressure inside the system, thus reducing the coupling and uncoupling loads.

Not last, it is an object of the present invention to provide a quick cartridge coupling which allows the male to be uncoupled thus leaving the latter under pressure after the disconnection.

This task and these and other objects which will become more apparent hereinafter are achieved by a cartridge coupling to connect a pressurized fluid line between a vehicle or apparatus and a user, comprising an external housing within which a female semi-coupling is inserted comprising a front valve assembly and adapted to receive a male semi-coupling, said housing comprising at least one recovery channel for the clean oil and one draining channel for the dirty oil, characterized in that it further comprises decompression means, on said female semi-coupling, to moderate the pressure inside the line thus facilitating the operations of coupling and uncoupling the male semi-coupling to/from said female semi-coupling.

The cartridge coupling according to the present invention is also characterized in that said decompression means allow the pressure in the female part to be moderated thus allowing a male under pressure to be coupled and uncoupled.

Again, the cartridge coupling according to the present invention is characterized in that it further comprises hydraulic blocking means adapted to prevent the front valve assembly from closing when the male coupling is inserted and regardless of the flow direction and pressure in the line, and adapted to allow the overtravel of said valve assembly required for the complete insertion of the male semi-coupling.

### BRIEF DESCRIPTION OF THE DRAWINGS

Further features and advantages of the present invention will become more apparent from the following detailed description, provided by way of non-limiting example and illustrated in the accompanying drawings, in which:

FIG. 1 shows a sectional view with a longitudinal plane of the cartridge coupling according to the present invention with a male semi-coupling inserted;

FIG. 2 shows a longitudinal sectional view of the cartridge coupling according to the present invention without male semi-coupling inserted;

FIG. 3 shows again a longitudinal sectional view of the detail indicated by letter A in FIG. 2;

FIG. 4 shows again a longitudinal sectional view of the detail indicated by letter B in FIG. 2;

FIG. 5 shows again a longitudinal sectional view of the cartridge coupling in FIG. 1 without the external housing;

FIG. 6 shows a detail of the cam-lever drive system of the decompression system cam of the cartridge coupling according to the present invention;

FIGS. 7 to 11 show a coupling cycle of the male in the female when both the semi-couplings are under pressure and without any intervention by the operator on the decompression means;

FIGS. 12 to 15 show a coupling cycle of the male in the female when both the semi-couplings are under pressure and with the intervention by the operator on the decompression means;

FIGS. 16 to 19 show an uncoupling cycle of the male in the female when there is pressure in the line and with the intervention by the operator on the decompression means, while leaving the male under pressure.

### DETAILED DESCRIPTION

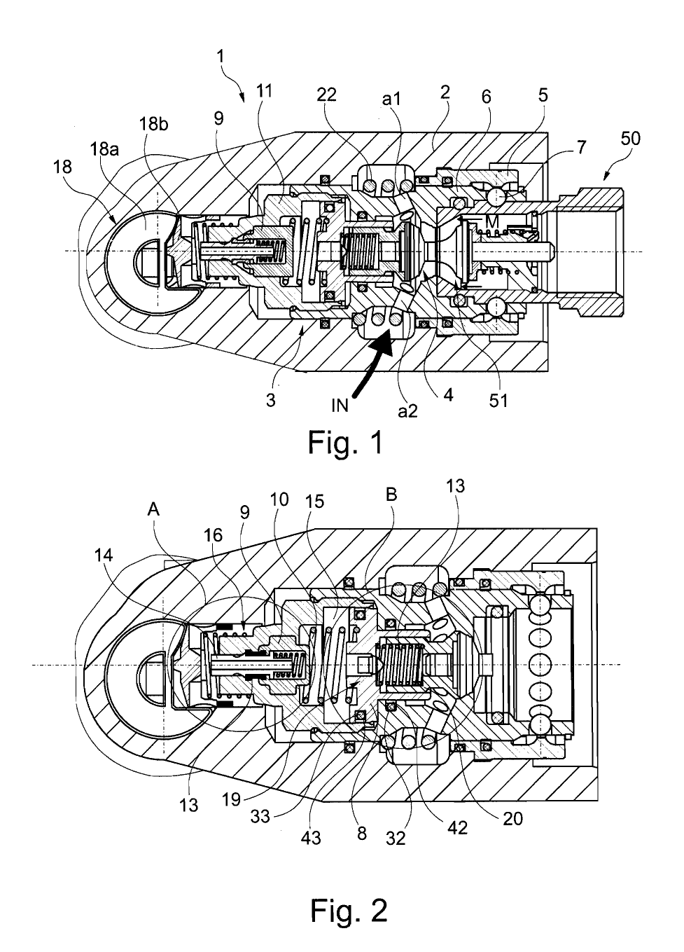

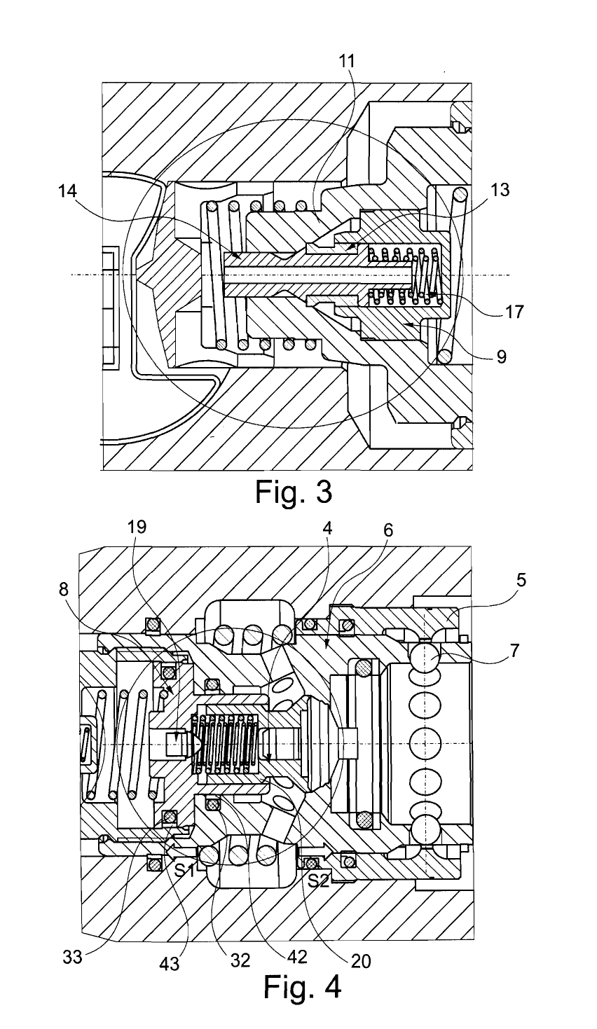

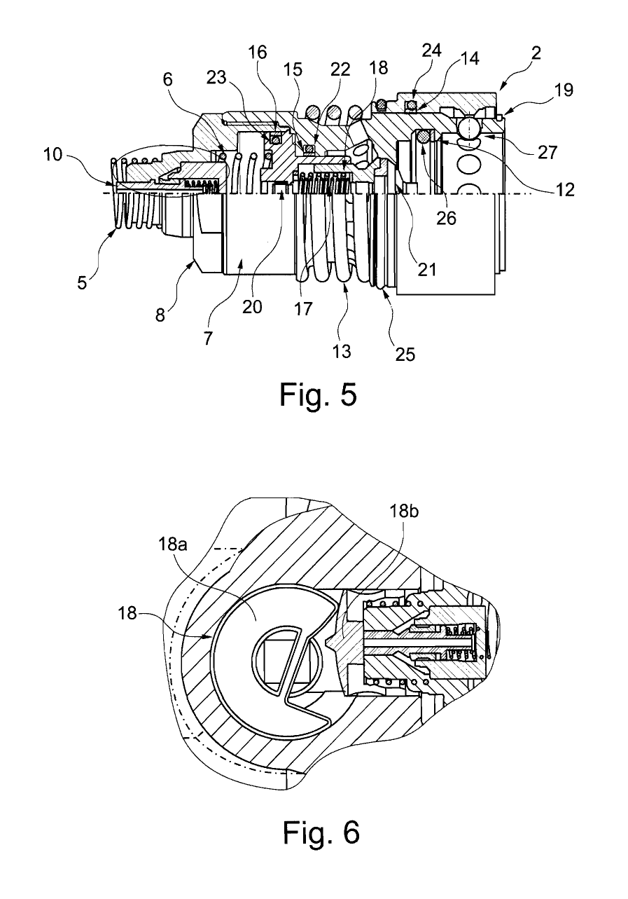

According to a preferred embodiment of the present invention shown in the mentioned figures by way of a non-limiting example, the cartridge coupling 1 according to the present invention comprises an external housing 2, preferably made of cast iron or other suitable material, in which a female semi-coupling 3 is housed. Such a female semi-coupling is of the type adapted to receive a male semi-coupling, and is preferably of the type in accordance with the features established by ISO Standard 7241. Several conduits are obtained in said external housing 2, for the circulation of the fluid, generally oil, which runs through the hydraulic line on which the semi-couplings are inserted. In particular, with reference to FIG. 1, the fluid enters the main supply conduit of the line according to the arrow indicated by IN thus supplying the female semi-coupling 3. The system then provides the collection of the dirty oil by means of a front draining channel included in housing 2 and not shown in the figures, while the clean oil is collected by means of a specific recovery channel for the clean oil, not shown in the figures as well, and put back into circulation.

Said female semi-coupling 3 comprises a ring nut 5 which is mechanically blocked with respect to the external housing 2, the ball set 6 is capable of axially translating with respect to body 2. The ball set 6, by means of the balls 7, is capable of ensuring the connection of the male semi-coupling, as shown in FIG. 1, as the balls 7 are capable of firmly keeping the male semi-coupling 50 as known in the field.

The valve assembly 4, provided in a substantially axial position, is capable of adhering to the walls of the internal clearance obtained inside the ball set 6 so as to close off the axial passageway to the fluid. As known again with reference to the accompanying figures, the input fluid from the main supply conduit according to the direction identified by the arrow IN reaches the area of the resetting spring 22 and enters the female semi-coupling from this area through the radial passage holes a1 and a2 until it reaches the valve assembly 4. As long as the male semi-coupling is not coupled, the valve assembly 4 closes the axial clearance of the female semi-coupling 3, as shown in FIG. 2. In this situation, the valve assembly 4 is pushed to close by the springs 13 and by the balancing slider 8.

The valve assembly 4 comprises a valve body 4a, equipped with a calibrated hole 20 adapted to put the interior of said valve body 4a in communication with the exterior, axially inserted in said balancing slider 8, more precisely inside an axial extension 8a of said balancing slider 8. The first spring 13 acts between said valve assembly and said balancing slider 8, thus exerting a reaction force to the reciprocal nearing of the two components.

Again with particular reference to the figures, a chamber 15 is present behind the valve assembly 4 and the balancing slider 8, which is filled with the pressurized fluid during the coupling operation. Said chamber is thus delimited by the balancing slider 8 and by the rear body 11, a second spring 10 acting between said rear body 11 and said balancing slider 8 by exerting a reaction force also in this case which opposes the reciprocal nearing of the two components.

An inner body 9 is provided inside said rear body 11 and integrally therewith, which is adapted to contain the movable equipment of the decompression valve, generally indicated by the reference number 16.

Said decompression valve, placed in an axial position at the end opposite to the semi-coupling 3 with respect to the front valve assembly 4, comprises a decompression rod 14 and a shaped gasket 13, adapted to make the seal between said inner body 9 and said rear body 11 and said decompression rod 14, as better disclosed below.

The decompression valve 16, comprising decompression rod 14, shaped gasket 13 and unbalancing spring 17 acting between said decompression rod and said inner body 9 allows the pressure to be discharged with our without the intervention of the cam and lever actuating means, generally indicated by reference number 18.

Said cam and lever decompression means 18 advantageously comprise at least one lever 18a manually operable by the user acting on one cam 18b suitably shaped and capable of selectively interacting with said decompression rod 14.

Said balancing slider 8 comprises an internal valve assembly 19 in an axial position, movable with respect to said balancing slider 8 and capable of allowing the pressurized fluid to pass towards chamber 15.

Again, said decompression valve 16 provides for the decompression rod 14 and the inner walls of rear body 11 being suitably shaped to make a cone-on-cone sealing in order to avoid the shaped gasket from being extruded. Moreover, said decompression rod 14 axially includes a hole which allows the oil to be discharged in the case of accumulation thereof in the rear chamber of the decompression assembly.

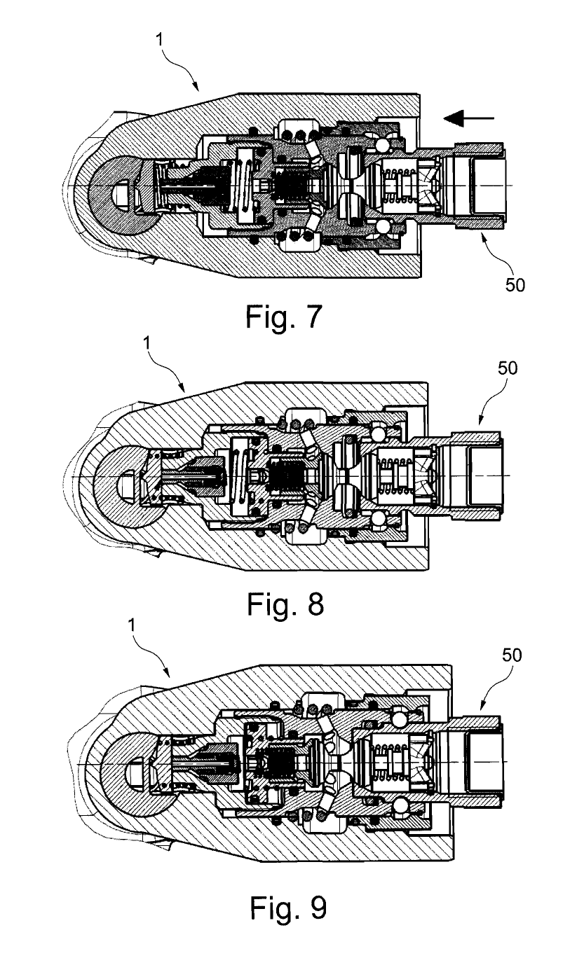

The operation of the cartridge coupling device according to the present invention will now be described again with reference to the accompanying figures, in particular with reference to FIGS. 7 to 19.

With reference to FIG. 7, the step of coupling the male semi-coupling 50 with the female semi-coupling 3 occurs with a single continuous manoeuvre. In the first attachment step, the male part pushes on the balls 7 of the ball set 6 which axially translates, thus moving back as shown in FIG. 7, pushed by the male until the balls 7 are inserted in specific grooves provided on the external surface of the male semi-coupling 50, as shown in FIG. 9.

In the situations in FIGS. 7 and 8, the respective valves of both the male semi-coupling 50 and the female semi-coupling 3, are closed. When the male semi-coupling 50 is inserted into the female semi-coupling 3, the ball set 6 moves back, as mentioned, and while moving back, also causes the rear body 11 and the balancing slider 8 to move back. The rear body 11 moving back causes the decompression valve 14 to abut against the cam 18b forming part of the decompression means 18, and the rod 14 being in abutment causes the relative translation of the rod itself with respect to the rear body 11, with consequential opening of the seal with gasket 13, i.e. opening of the decompression valve of the female semi-coupling 3. Thereby, the pressure in chamber 15 begins to discharge, and as the pressure decreases the internal valve assembly 19 opens, thus allowing the input fluid pressure in the female coupling through the calibrated hole 20 and the internal valve assembly 19, to be further discharged through the decompression valve 16.

Therefore, the operation of coupling the male semi-coupling 50 may be completed as shown in FIG. 9 even without any intervention by the operator on the decompression means 18 due to the pressure in the female semi-coupling 3 being discharged.

In the configuration in FIG. 9, the male is completely coupled and the pressure discharged in the female semi-coupling 3 allows the valve assembly 4 to be moved back, i.e. the opening of the valve of the female semi-coupling 3 due to the overtravel of the valve assembly 4.

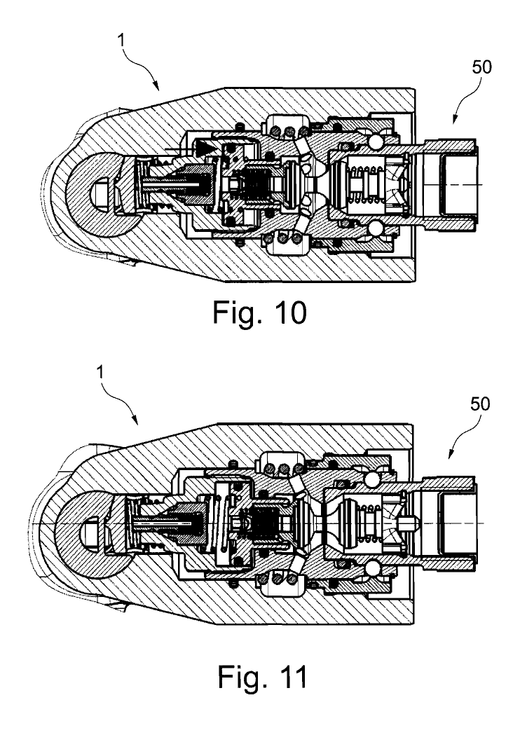

The valve assembly 4, pushed by the valve 51 of male 50, moves back by performing the overtravel until the balls of the female find the male groove. At this point, by releasing the male, the resetting spring 22 moves the ball set 6 forward while dragging the rear body 11 therewith, which is threaded thereto. The decompression rod 14 detaches from the cam, and springs 17 close the decompression valve as shown in FIG. 10.

At this point, the decompression valve is closed, therefore the pressure which fills the chamber 15 helps spring 10 push the balancing slider 8 forward, i.e. towards the male 50. The balancing slider 8 in turn pushes the valve assembly 4 and, due to the diameter size of the balancing slider 8 as compared to the dimensions of the valve assembly 51 of the male semi-coupling 50, the valve of the male semi-coupling is opened and therefore the line is opened, even with lower fluid pressures in the female as compared to those in the male.

In particular, the quick cartridge coupling according to the present invention is sized so as to have a 3:1 ratio between the pushing action exerted on the valve assembly 4, by means of balancing slider 8 and chamber 15, and the resistance force exerted by the pressure acting on the valve body 51 of the male semi-coupling 50. The male semi-coupling 50 is coupled and the valve 51 is opened due to this size ratio even when there is fluid with very high pressures in the user line to which the male is connected.

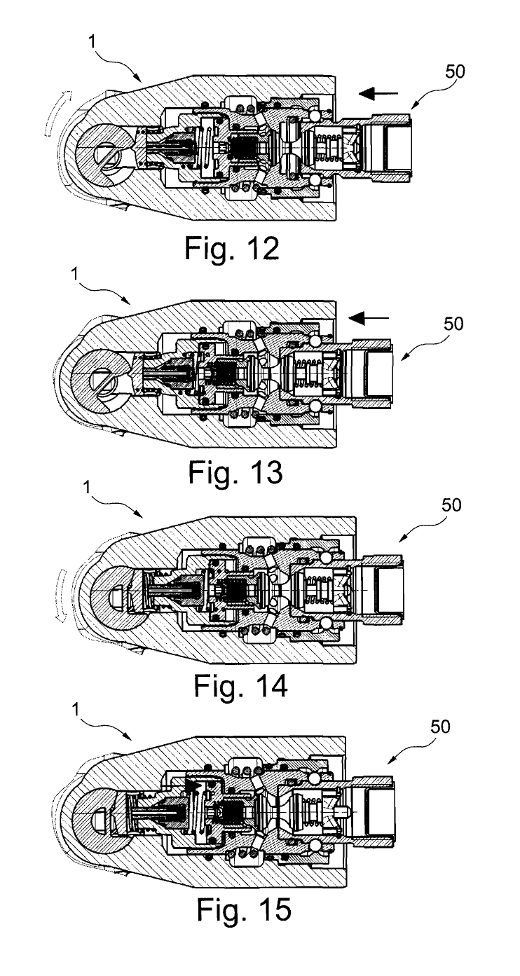

FIGS. 12 to 15 show the same sequence of inserting a male semi-coupling 50 into the female semi-coupling of the cartridge according to the present invention in which, however, the decompression of the female line occurs by means of the action by the operator on the decompression means 18. As shown in FIG. 12, the operator operates the lever 18a, integral with a cam in order to open the decompression valve 14 by means of pusher 18b. Once the pressure in the female semi-coupling 3 has been discharged, the operator may complete the insertion of the male semi-coupling 50, as shown in FIG. 13.

Once the insertion of the male semi-coupling has been completed, the operator should release the lever 18a to close the decompression valve 14 (FIG. 14), and let the chamber 15 be filled with pressurized fluid so as to allow the forces acting on the two valve assemblies 4 and 51 to be unbalanced and so the male-female connection to be opened.

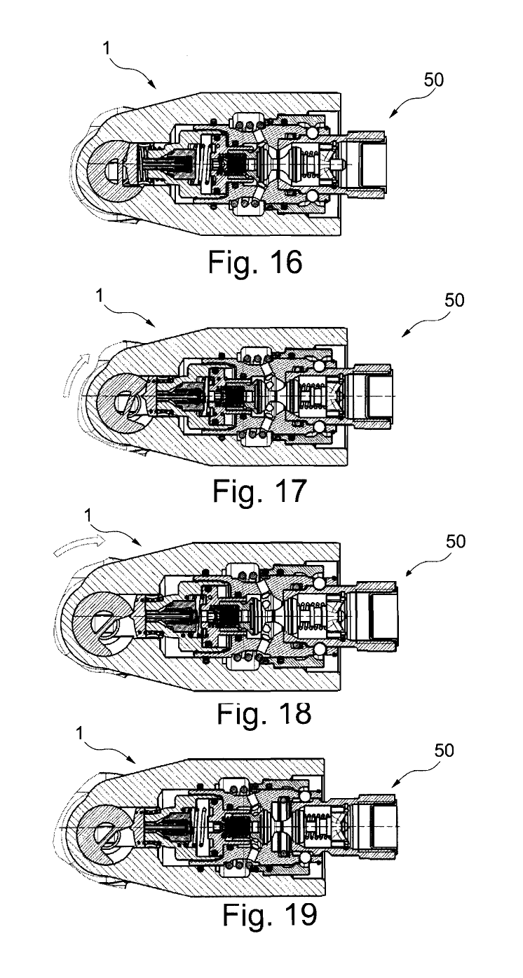

To complete the description, FIGS. 16 to 19 show the sequence of the operations required to disconnect the male by using the lever when the line is under pressure. As shown in FIG. 17, the operator operates lever 18a thus causing the opening of the decompression valve 16 even if there is pressurized fluid in the line. Thus the pressure is discharged from the female semi-coupling 3, the valve assembly (FIG. 4) may perform the overtravel while moving back, allowing the valve assembly 51 of the male semi-coupling 50 to close. Once the valve of the male semi-coupling is closed, a further rotation of the lever and cam 18a causes the integral forward movement of the rear assembly 11 and of the ball set 6, with consequential release of the balls 7 from the seats obtained on the external surface of the male, which thus may be finally taken off by the operator.

Naturally, as mentioned, opening the decompression valve 16 allows the line to be discharged by means of the clean oil conduit and to be recovered into the hydraulic circuit.

According to a preferred embodiment of the present invention shown in the accompanying figures, the decompression valve 16 is characterized by an elastomeric sealing system on the rear body 11 and by a metal cone-on-cone abutment to avoid the gasket from being extruded.

Component 9 is forced onto the rear body 11 by means of a shaped gasket 13 which creates a balanced sealing between the rear body 11 and the inner body 9, and is provided with four recesses for the fluid passing—this causes that the force required to move the decompression rod back is independent from the pressure level. This balancing is obtained due to the particular shape of the gasket, and the rod of the decompression valve is suitably holed to avoid the “syringe effect” and therefore permit the axial travel.

The cartridge coupling according to the present invention provides a 3:1 balancing system of the forces acting on the valves of the female semi-coupling and of the male semi-coupling, so as to facilitate also the opening of the valve of the male coupling with a pressure up to three times less in the part of the female semi-coupling.

Said balancing is obtained by means of the suitable sizing of the diameter of the balancing slider 8, on the crown of which the pressure force acts due to the fluid in chamber 15 according to the arrows F in FIG. 1, and of the valve assembly 51 on the crown of which the fluid pressure acts according to the arrows indicated by M, again in FIG. 1. By suitably sizing the thrusting crown of the balancing slider 8, a 3:1 ratio has been obtained of the thrust forces due to the fluid pressure in favour of the thrust acting on the valve assembly 4 of the female semi-coupling. This unbalancing facilitates opening the valve assembly 51 of the male when the male semi-coupling is under pressure.

Therefore, due to their sizing, chamber 15 and balancing slider 9 are the hydraulic blocking means as they prevent obstructions and/or fluid passageway reductions even in the presence of sudden flow variations.

It is worth noting how the balancing slider 8 is associated with the rear body 11 by means of sealing elements 32, 33 and anti-extrusion means 42, 43. In the example shown in the figures, e.g. in FIG. 2, the sealing elements 32 and 33 consist of O-ring gaskets, whereas the anti-extrusion means 42 and 43 consist of suitable shoes.

This configuration reduces the sliding friction with significant benefits on the coupling loads.

It has thus been shown how the cartridge coupling according to the present invention, characterized by a compact design and having smaller dimensions which permit the arrangement thereof in narrow spaces, allows the above-set task and objects to be achieved.

In particular it has been shown how the cartridge coupling according to the present invention allows the coupling and uncoupling loads to be reduced, thus facilitating the coupling and uncoupling operations even when there is pressurized fluid in the line, regardless of whether the pressurized fluid is in the male semi-coupling or in the female semi-coupling.

Again, the cartridge coupling according to the present invention allows a male to be inserted when there is fluid under pressure in the latter and the male to be disconnected while leaving it under pressure.

Several modifications may be made by the person skilled in the art without departing from the scope of protection of the present invention.

Hence, the scope of protection of the claims should not be limited by the disclosures or preferred embodiments shown in the description by way of example, but rather the claims should comprise all features of patentable novelty inferable from the present invention, including all features which would be treated as equivalent by the person skilled in the art.

What is claimed is:

1. A cartridge coupling of the type adapted to connect a pressurized fluid line between a vehicle or apparatus and a user, comprising an external housing within which a female semi-coupling is inserted, comprising a front valve assembly and adapted to receive a male semi-coupling being also equipped with a valve assembly, said housing comprising at least one main supply channel, a recovery channel for the clean oil and one draining channel for the dirty oil, and further comprising decompression means, on said female semi-coupling, to moderate the pressure inside the line thus facilitating the operations of coupling and uncoupling the male semi-coupling to/from said female semi-coupling, and further comprising an internally hollow ball set capable of translating with respect to said housing and integral with a rear body, which is also internally hollow and in which a balancing slider is housed, slidingly associated therewith, wherein said decompression means comprise a decompression valve placed in a substantially axial position at the end opposite to said semi-coupling with respect to the front valve assembly and adapted to discharge the oil in said recovery channel for the clean oil, a chamber adapted to be filled with pressurized fluid during the coupling operation is provided inside said rear body, being closed on one side by said balancing slider slidingly associated with said rear body, and in that said decompression valve comprises a decompression rod, equipped with an axial through hole, inserted into an inner body with which it is slidingly associated by means of a spring, and adapted to make a seal of elastomeric type with the inner walls of said rear body, said inner body being firmly associated with said rear body and adapted to put said rod in communication with said chamber.

2. A cartridge coupling according to the preceding claim, wherein said valve assembly is pushed to close the internal fluid passageway clearance of the female semi-coupling by the action of a first spring acting on said balancing slider, placed behind said valve assembly.

3. A cartridge coupling according to the preceding claim, wherein said valve assembly has an inner cavity and is coaxial to said balancing slider and is slidingly associated therewith.

4. A cartridge coupling according to the preceding claim, wherein said valve assembly has a calibrated hole adapted to put the inner cavity of said valve body in communication with the exterior.

5. A cartridge coupling according to the preceding claim, wherein said balancing slider comprises an internal valve assembly in an axial position adapted to put said chamber in communication with said inner cavity of said valve assembly.

6. A cartridge coupling according to the preceding claim, wherein said decompression valve is also manually operable by means of cam and lever actuating means
